(19) United States
(12) Patent Application Publication
(10) Pub. No.: US 2026/0176429 A1
(43) Pub. Date: Jun. 25, 2026

(54) MICROCOMPOSITE COMPRISING A NUCLEATING COMPONENT AND A THERMOPLASTIC POLYMER

(71) Applicant: ARIEL SCIENTIFIC INNOVATIONS LTD., Ariel (IL)

(72) Inventor: Theodor STERN, Jerusalem (IL)

(21) Appl. No.: 19/127,799

(22) PCT Filed: Nov. 10, 2023
(86) PCT No.: PCT/IB2023/061367

§ 371 Date: May 7, 2025

Related U.S. Application Data
(60) Provisional application No. 63/424,147, filed on Nov. 10, 2022.

(51) Int. Cl. C08J 5/10; C08K 7/06

(52) U.S. Cl. CPC C08J 5/10; C08K 7/06; C08K 2201/005

(57) ABSTRACT

Disclosed are microcomposites comprising one or more microcomposite units where each microcomposite unit includes a nucleating component with a nucleating surface and a porous transcrystalline layer made of a crystallizable thermoplastic polymer covering the nucleating surface where the microcomposite is devoid of a bulk polymer matrix phase and, in some preferred embodiments is also substantially devoid of amorphous thermoplastic polymer in the pores of the transcrystalline layer, and methods of making the same.

### RELATED APPLICATION

The present application gains priority from U.S. provisional patent application U.S. 63/424,147 filed 10 Nov. 2022, which is incorporated by reference as if fully set-forth herein.

### FIELD AND BACKGROUND OF THE INVENTION

The invention, in some embodiments, relates to the field of composite materials and more particularly, but not exclusively, to microcomposites comprising one or more microcomposite units where each microcomposite unit includes a nucleating component with a nucleating surface and a porous transcrystalline layer made of a crystallizable thermoplastic polymer covering the nucleating surface where the microcomposite is devoid of a bulk polymer matrix phase and, in some preferred embodiments is also substantially devoid of amorphous thermoplastic polymer in the pores of the transcrystalline layer, and methods of making the same.

A composite comprises at least two different constituent materials having significantly-different chemical and/or physical properties, the constituents are present in the composite as separate phases that are mutually strongly bonded. As a result, even though each of the components retains their original properties, the composite has substantially different properties from those of the constituents.

One example of a composite is a fiber-reinforced composite in which fibers are embedded and strongly bonded to a continuous matrix. A fiber-reinforced composite possesses advantageous mechanical properties, at least partially due to the transfer of stress from the matrix to the embedded fibers. Less-than optimal matrix-fiber bonding (e.g., due to weak bonding or the presence of flaws) leads to fiber-reinforced composite having mechanical properties that fall short of the theoretically-calculated properties. Improved bonding is achieved by selecting a fiber/matrix combination that bonds well, for example, have similar polarity. In industry, most fiber-reinforced composites are made of a fiber and matrix that are of two different polymers, for example aramid fibers (Kevlar®) in an epoxy resin matrix.

A microcomposite is a composite where each microcomposite unit comprises a small number of individual reinforcing component embedded in a bulk polymer matrix some of which have a nucleating surface. Typically, the reinforcing components are fibers having a diameter of between 1 and 1000 micrometers. The small number is from 1 up to 20 reinforcing components in each microcomposite unit. Examples of microcomposites have been described in the literature, see for example, Stern T, Wachtel E, Marom G in Composites A 1997, 28A, 467-444; Stern T, Wachtel E, Marom G in J Poly Sci B Poly Phys 1997, 35, 2429-2433; and Stern T, Teishev A, Marom G in Comp Sci Tech 1997, 57, 1009-1015. In microcomposites having multiple fibers in each microcomposite unit, the fibers in an individual unit are typically arranged in a specific way, e.g., all are parallel and preferably do not contact. For non-fiber reinforcement, the individual nucleating components preferably do not contact each the other. The polymer matrix of a microcomposite is any suitable polymer matrix, typically an epoxy. Microcomposites are mostly used as models for research purposes and/or for facilitating the measurement of micro-properties, such as micro-mechanics, critical fiber length, interfacial bonding and thermal expansion.

Some polymer compositions include only non-crystallizable fractions and solidify from a melt to form an amorphous non-crystalline solid.

Most polymer compositions are crystallizable polymer compositions having both a crystallizable fraction and a non-crystallizable fraction. Due to the presence of the non-crystallizable fraction, under crystallization conditions a melt of crystallizable polymer compositions solidifies to form a semicrystalline solid having an isotropic bulk polymer matrix phase of primarily the non-crystallizable fraction in which are interspersed a crystalline phase of the crystallizable fraction. The crystalline phase has a lamellar structure. The constituent lamellae of the lamellar structure of the crystalline phase are of varying lengths and complicated spatial configuration, but are always of nanoscale thickness. Within the inter-lamellar gaps is an amorphous phase which is made of the non-crystallizable fraction that was expelled from the crystallizable fraction during formation of the lamellae. One mechanism that forms such lamellae is polymeric chain-folding crystallization which occurs in the direction normal to the axial direction of the lamellae, see for example “Shifting Paradigms in Polymer Crystallization” by Muhukumar M in Lect. Note Phys 2007, 714, 1-18. Typically, polymers freely crystallize in a bulk forming lamellar structures that constitute multi-lamellar quasi-spherical crystals called spherulites.

One type of fiber-reinforced composite comprises a thermoplastic semicrystalline polymer matrix with embedded semicrystalline polymer fibers or crystalline non-polymer fibers. Such fiber-reinforced composites are typically made by melting a matrix-precursor thermoplastic polymer in the presence of the fibers (preferably previously being arranged in a desired relative orientation) and then allowing the molten thermoplastic polymer to cool and solidify under crystallization conditions to form the semicrystalline polymer matrix.

In such methods, the surface of a crystalline or semicrystalline fiber acts as a strong, dense and heterogeneous nucleating agent for crystallizable polymer compositions. As a result, when crystallization of a thermoplastic polymer composition occurs in the presence of a crystalline or semicrystalline fiber, crystallization invariably starts on the fiber surface. The polymer crystals grow radially outwards from the fiber surfaces in an ordered structure that encases each fiber, the ordered structure is called a transcrystalline layer see for example, Stern T, Wachtel E, Marom G in Composites A 1997, 28A, 467-444; Stern T, Wachtel E, Marom G in J Poly Sci B Poly Phys 1997, 35, 2429-2433; and Stern T, Teishev A, Marom G in Comp Sci Tech 1997, 57, 1009-1015.

Similarly, it is possible to have a crystalline or semicrystalline nucleating surface that is not the surface of a fiber. Analogously to the surface of a fiber, in the presence of a non-fiber nucleating surface the crystallization of a thermoplastic polymer composition starts on the nucleating surface. The polymer crystals grow outwards from the nucleating surface in an ordered structure that covers the surface,

Due to the inherently very significant time-lapse between the crystalline nucleation on the fiber or non-fiber nucleating surface (starts sooner) and in the bulk matrix (starts later), the transcrystalline layer starts growing and reaches a significant thickness before the formation of crystals in the surrounding bulk matrix. As a consequence, a transcrystalline layer typically has a number of characteristics.

A transcrystalline layer is typically characterised by a continuously high nucleation density, and consequently, completely covers a nucleating surface, without significant gaps or interruptions in the continuity of the transcrystalline layer. When the nucleating surface is the outer surface of a fiber, the transcrystalline layer can be considered a continuous dense sheath surrounding the fiber.

A transcrystalline layer is typically characterized as having a significant thickness. When the nucleating surface is the outer surface of a relatively thin fiber (e.g., less than about 10 micrometer diameter), the transcrystalline “sheath” typically has a diameter greater than that of the fiber.

A transcrystalline layer exhibits a nanolamellar structure that is inherently a highly-ordered and unidirectionally-oriented. As a result, the transcrystalline layer is anisotropic as opposed to the bulk matrix which is essentially isotropic. When the nucleating surface is the outer surface of a fiber, the nanolamellae are oriented radially outwards from the fiber surface.

The presence of a transcrystalline layer surrounding fibers in such a fiber-reinforced composite having a thermoplastic matrix is known to provide improved mechanical properties due to improved matrix-fiber bonding and due to the enhanced physical properties of the transcrystalline layer.

### SUMMARY OF THE INVENTION

The invention, in some embodiments, relates to the field of composite materials and more particularly, but not exclusively, to microcomposites comprising one or more microcomposite units where each microcomposite unit includes a nucleating component with a nucleating surface and a porous transcrystalline layer made of a crystallizable thermoplastic polymer covering the nucleating surface where the microcomposite is devoid of a bulk polymer matrix phase and, in some preferred embodiments is also substantially devoid of amorphous thermoplastic polymer in the pores of the transcrystalline layer, and methods of making the same.

According to an aspect of some embodiments of the teachings herein, there is provided a microcomposite comprising one or more microcomposite units, wherein each microcomposite unit includes:
at least one nucleating component having a nucleating surface; and
nucleated from the nucleating surface, a porous transcrystalline layer of crystallizable thermoplastic polymer,
   wherein the microcomposite is substantially devoid of a bulk polymer matrix phase in the volume outside of the porous transcrystalline layer. Preferably, a microcomposite according to the teachings herein is devoid of any spherulitic structure.

In some embodiments, the lack of bulk polymer matrix phase that indicates that the microcomposite is substantially devoid of a bulk polymer matrix phase in the volume outside of the porous transcrystalline layer is determined by examination of a Scanning Electron Microscopy (SEM) image acquired with a magnification of ×2500 at a working distance of 52 mm and acceleration voltage of 5 kV and determining that the image:
includes at least a portion of one or more transcrystalline layers of one or more microcomposite units,
possibly includes at least a portion of one or more nucleation components of one or more microcomposite units,
is devoid of any polymer material outside of a transcrystalline layer, and
is devoid of any spherulitic structure.

In some embodiments, the pores of the porous transcrystalline layer contain amorphous thermoplastic polymer.

In some alternative embodiments, the pores of the porous transcrystalline layer are substantially devoid of amorphous thermoplastic polymer. In some such embodiments, the pores of the porous transcrystalline layer being substantially devoid of amorphous thermoplastic polymer is determined by examination of a Scanning Electron Microscopy (SEM) image acquired with a magnification of ×2500 at a working distance of 52 mm and acceleration voltage of 5 kV and determining that not less than about 95% of the pores seen in the image from directly above the pore opening are empty and devoid of amorphous thermoplastic polymer. In some embodiments, the pores of the porous transcrystalline layer being substantially devoid of amorphous thermoplastic polymer is determined by the microcomposite having a degree of crystallinity of not less than about 95% as determined by Differential Scanning Calorimetry (DSC) using a heating rate of 10° C./minute.

In some embodiments, the at least one nucleating component is a small number greater than one of individual nucleating components.

In some embodiments, the at least one nucleating component is a single nucleating component.

In some embodiments, the microcomposite comprises at least two the microcomposite units, wherein not less than about 30% by weight of the microcomposite units of the microcomposite are physically-separable one from the other.

In some embodiments, at least one dimension of the nucleating component is not greater than about 1 mm.

In some embodiments, the porous transcrystalline layer is not less than about 0.1 micrometers thick and not more than about 200 micrometers thick.

In some embodiments, the transcrystalline layer constitutes not less than about 90% by volume of a corresponding microcomposite unit.

In some embodiments, the nucleating component comprises a fiber.

According to an aspect of some embodiments of the teachings herein, there is provided method of manufacturing a microcomposite, comprising:
a. providing a melt that comprises a chosen crystallizable thermoplastic polymer, the melt being at a first temperature;
b. providing at least one nucleating component having a nucleating surface;
c. subsequent to ‘a’ and ‘b’, intimately contacting at least part of the nucleating surface of the at least one nucleating component with the melt;
d. subsequent to ‘c’, lowering the temperature of the melt that is in intimate contact with the part of the nucleating surface to a second empirically-predetermined isothermal temperature, lower than the first temperature, at which a transcrystalline layer is nucleated and formed on the nucleating surface intimately contacting the melt and no crystallization occurs in the bulk matrix melt beyond the transcrystalline layer, thereby making an incipient microcomposite comprising the formed transcrystalline layer nucleated on the nucleating surface where pores of the transcrystalline layer are filled with an amorphous polymer phase and bulk polymer matrix melt is outside of the transcrystalline layer;
e. subsequent to ‘d’, when the transcrystalline layer that is formed on portions of the nucleating surface is of a desired thickness and/or has stopped growing, immersing the nucleating surface, the formed transcrystalline layer and bulk polymer matrix melt that is adhered thereto in an extraction solvent suitable for extracting the chosen thermoplastic polymer, so as to remove substantially all of the adhered bulk polymer matrix melt from the outside of the formed transcrystalline layer of the incipient microcomposite, thereby making a microcomposite comprising at least one microcomposite unit that includes at least one nucleating component having a nucleating surface; and nucleated from the nucleating surface, a porous transcrystalline layer of crystallizable thermoplastic polymer, wherein the made microcomposite is substantially devoid of a bulk polymer matrix phase in the volume outside of the porous transcrystalline layer; and
f. removing the microcomposite from immersion in the extraction solvent.

In some embodiments, subsequently to ‘f’, the method further comprises removing any extraction solvent from the microcomposite, preferably by blotting.

In some embodiments, the intimately contacting ‘c’ at least part of the nucleating surface of the at least one nucleating component with the melt comprises at least partially immersing the at least one nucleating component in the melt so that at least a portion of the nucleating surface is in intimate contact with the melt.

Alternatively, in some embodiments the intimately contacting ‘c’ at least part of the nucleating surface of the at least one nucleating component with the melt comprises coating at least a portion of the nucleating surface with the melt so that the nucleating surface is in intimate contact with the melt.

In some embodiments, the immersing ‘e’ of the nucleating surface and the formed transcrystalline layer in the extraction solvent is sufficient to remove substantially all of the amorphous polymer phase from the pores of the transcrystalline layer.

In some embodiments, the melt comprises, in addition to the crystallizable thermoplastic polymer a chosen amount of an additive:
the additive being a liquid under the crystallization conditions of the crystallizable thermoplastic polymer from the melt;
the additive being miscible with the crystallizable thermoplastic polymer in the melt so that the melt is homogeneous; and
the additive does not phase-separate from the melt.

Aspects and embodiments of the invention are described in the description hereinbelow and in the appended claims and Figures.

As used herein, the term “unidirectionally-oriented” means that the polymeric crystalline lamellae making up a transcrystalline layer grow from and are substantially perpendicular to a nucleating surface.

In some instances herein, especially in the priority document the term “phase with a nucleating surface” and variants thereof is used as a synonym for the term “nucleating component with a nucleating surface” and variants thereof.

In some instances herein, especially in the priority document the term “transcrystalline phase” and variants thereof is used as a synonym for the term “transcrystalline layer” and variants thereof.

### BRIEF DESCRIPTION OF THE FIGURES

Some embodiments of the invention are described herein with reference to the accompanying figures. The description, together with the figures, makes apparent to a person having ordinary skill in the art how some embodiments of the invention may be practiced. The figures are for the purpose of illustrative discussion and no attempt is made to show structural details of an embodiment in more detail than is necessary for a fundamental understanding of the invention. For the sake of clarity, some objects depicted in the figures are not to scale.

In the Figures:

FIG. 1 (prior art) is a scanning electron microscope (SEM) image of a HDPE (high-density polyethylene) first control film made by melting HDPE polymer between two glass slides and letting the molten polymer crystallize by cooling at room-temperature in the air while held between the glass slides. After solidification, the semicrystalline film was removed from between the slides. Although only amorphous non-crystallized HDPE is seen in the SEM image, the pattern on the surface indicates the presence of some polymer crystals embedded inside the dominant amorphous phase.

FIG. 2 (prior art) is a scanning electron microscope (SEM) image of a carbon-fiber reinforced HDPE (high-density polyethylene) second control composite film made by immersing carbon fibers having a diameter of ˜5 micrometer in molten HDPE thermoplastic polymer (the same HDPE as in FIG. 1) and letting the molten HDPE cool at room-temperature in the air in the presence of the fibers. In FIG. 2 two partially-exposed carbon fibers and fracture fragments thereof are seen together with the amorphous phase of HDPE on the surface of the HDPE matrix.

FIGS. 3A and 3B are scanning electron microscope (SEM) images of an embodiment of a microcomposite according to the teachings herein, having microcomposite units comprising carbon fibers having a diameter of ˜5 micrometers (‘f’), the same as used in FIG. 2) encased in an HDPE transcrystalline layer (‘t’), where the HDPE is the same HDPE as used in FIGS. 1 and 2.

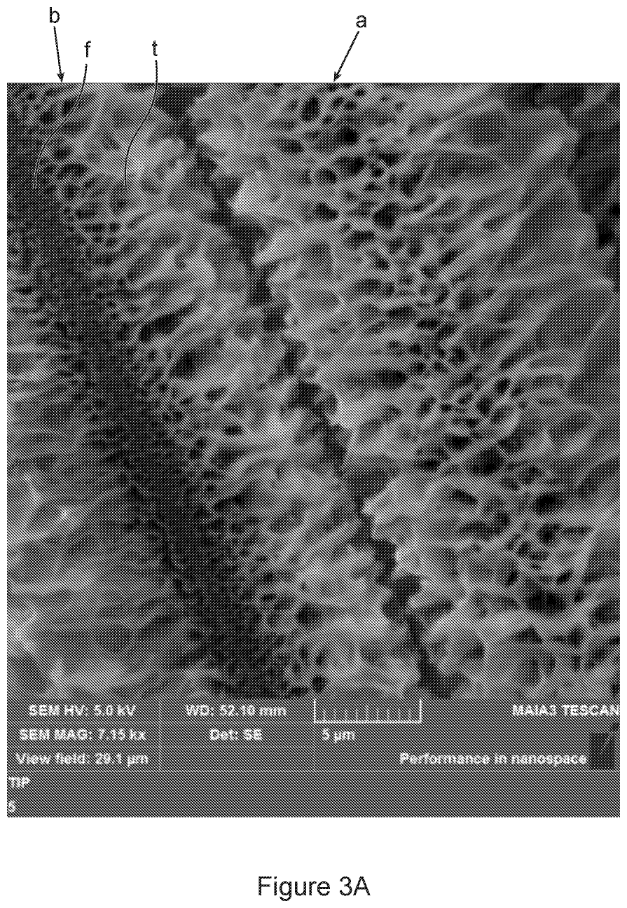

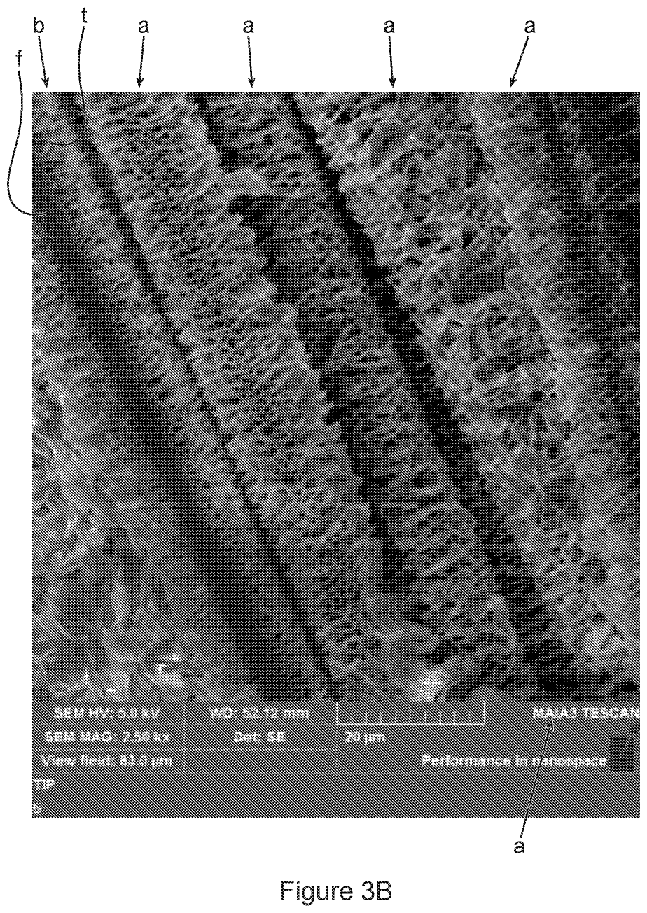

In FIG. 3A, two parallel independent microcomposite units (‘a’ and ‘b’) according to the teachings herein, each unit (‘a’ or ‘b’) including a single carbon fiber ‘f’ encased in a transcrystalline layer (‘t’ of HDPE, are visible from the side:
in unit ‘a’, the constituent fiber is completely encased in the transcrystalline layer so that only the outer porous surface of the transcrystalline layer is visible and the porous structure therein, and
in unit ‘b’, the portion of the porous transcrystalline layer (labelled ‘t’ facing the viewer is broken to expose the constituent fiber (labelled ‘f’) and the internal structure of the transcrystalline layer.

In FIG. 3A, the transcrystalline layer of the microcomposite units ‘a’ and ‘b’ is devoid of an amorphous phase. Also, there is no polymeric matrix extending beyond the transcrystalline layer encasing each fiber.

In FIG. 3B, five parallel independent microcomposite units (‘a’ and ‘b’) according to the teachings herein are visible from the side:
in the four units labelled ‘a’ the constituent fiber is completely encased in a transcrystalline layer so that only the porous outer surface of the transcrystalline layer is seen, and in unit ‘b’ the portion of the porous transcrystalline layer (‘t’) facing the viewer is broken exposing the constituent fiber (‘f’) and the internal structure of the transcrystalline layer (‘t’).

As seen in FIG. 3B, the transcrystalline layer of the five microcomposite units ‘a’ and ‘b’ is devoid of an amorphous phase. Also, there is no polymeric matrix extending beyond the transcrystalline layer encasing each fiber.

In both FIGS. 3A and 3B, it is seen that the pores in the transcrystalline layers are open-celled structures.

In both FIGS. 3A and 3B, it is seen that the majority of pores in the transcrystalline layers extend directly or by interconnections, from the fiber (nucleating) surface to the outer surface of the transcrystalline layer of each microcomposite unit.

In both FIGS. 3A and 3B, it is seen that the transcrystalline layer has a consistently-increasing pore size, with pores close to the fiber surface being the smallest and pores at the outer surface of the transcrystalline layer of the microcomposite being the largest.

In both FIGS. 3A and 3B, it is seen that the fiber-surface contacting base of the transcrystalline layer exhibits a continuously high nucleation density, leading to a continuous uniform transcrystalline layer covering the entire surface of the fiber, without gaps or interruptions. The constituent crystalline lamellae of the transcrystalline layer are nucleated on the fiber surface and grow outwards from the fiber surface, in a consistent direction generally perpendicular to the fiber surface.

### DESCRIPTION OF SOME EMBODIMENTS OF THE INVENTION

The invention, in some embodiments, relates to the field of composite materials and more particularly, but not exclusively, to microcomposites comprising one or more microcomposite units where each microcomposite unit includes a nucleating component with a nucleating surface and a porous transcrystalline layer made of a crystallizable thermoplastic polymer covering the nucleating surface where the microcomposite is devoid of a bulk polymer matrix phase and, in some preferred embodiments is also substantially devoid of amorphous thermoplastic polymer in the pores of the transcrystalline layer, and methods of making the same.

The principles, uses and implementations of the teachings of the invention may be better understood with reference to the accompanying description and figures. Upon perusal of the description and figures present herein, one skilled in the art is able to implement the teachings of the invention without undue effort or experimentation. In the figures, like reference numerals refer to like parts throughout.

Before explaining at least one embodiment of the invention in detail, it is to be understood that the invention is not necessarily limited in its application to the details of construction and the arrangement of the components and/or methods set forth herein. The invention is capable of other embodiments or of being practiced or carried out in various ways. The phraseology and terminology employed herein are for descriptive purpose and should not be regarded as limiting.

### Microcomposite

A microcomposite according to the teachings herein is a microcomposite comprising one or more microcomposite units where each microcomposite unit includes:
at least one nucleating component having a nucleating surface; and
nucleated from the nucleating surface, a porous transcrystalline layer of a crystallizable thermoplastic polymer,
   wherein the microcomposite is substantially devoid of a bulk polymer matrix phase in the volume outside of the transcrystalline layer. Preferably, a microcomposite according to the teachings herein is devoid of any spherulitic structure.

### Microcomposite Unit

Herein are disclosed microcomposites. A microcomposite according to the teachings herein comprises one or more microcomposite units that includes at least one nucleating component having a nucleating surface, and nucleated from the nucleating surface, a porous transcrystalline layer of crystallizable thermoplastic polymer. The term “nucleated” is as used by a person having ordinary skill in the art, i.e., that the nucleating surface served as a nucleator from which the transcrystalline layer started to crystallize. Typically, the transcrystalline layer is attached to the nucleating surface. Typically, the transcrystalline layer covers to the nucleating surface.

A microcomposite unit most typically comprises a single nucleating component having a nucleating surface from which is nucleated a porous transcrystalline layer of a crystallizable thermoplastic polymer. As seen in FIGS. 3A and 3B, the microcomposite units ‘a’ and ‘b’ all consist of a single carbon fiber that is the nucleating component and the outer surface of the carbon fiber is the nucleating surface. Nucleated from the nucleating surface is the transcrystalline layer. It is seen that the transcrystalline layer is attached to the surface of the carbon fiber. It is also seen that the transcrystalline layer is dense, completely covering the surface of the carbon fiber.

In some non-depicted instances, a single microcomposite unit includes a small number (from 2 to up to and including 20) of individual nucleating components. In typical such instances, the nucleating components were in physical contact or very close together when the nucleating of the transcrystalline layer started so that, for the transcrystalline layer, the nucleating surfaces of the multiple nucleating components are effectively a single combined nucleating surface.

### Substantially Devoid of of a Bulk Polymer Matrix Phase

As discussed in the introduction, crystallizable polymer compositions (including thermoplastic polymers) are semicrystalline thus typically have both a crystallizable fraction and a non-crystallizable fraction. Under crystallization conditions, crystallizable polymer compositions form semicrystalline solids. In typical bulk crystallization, the polymer crystals are commonly in the form of quasi-spherical crystals called spherulites that are intercalated and interspaced by the excluded non-crystallizable polymeric amorphous phase.

During the production of some prior art composites and microcomposites, a melt comprising a crystallizable polymer with dispersed-phase components (typically fibers) immersed in the melt is allowed to cool. During the cooling, some of the crystallizable fraction of the crystallizable polymer crystallizes in the usual way forming lamellar spherulites, forming the semicrystalline bulk matrix of the composite which is commonly isotropic. Additionally, some of the crystallizable fraction of the crystallizable polymer nucleates on the surface of the components of the dispersed phase and crystallizes in a direction away from the surface, forming a transcrystalline layer, commonly consisting of non-spherulitic lamellar transcrystals forming a generally unidirectional anisotropic layer. During formation of the transcrystalline layer, non-crystallizable fractions of the crystallizable polymer are expelled from the forming transcrystalline lamellae creating inter-lamellar gaps typically in the form of pores in the transcrystalline layer in which the amorphous phase accumulates. When cooling is complete, the composite or microcomposite comprises an isotropic semicrystalline bulk polymer matrix phase in which are interspersed polymer crystals not associated with dispersed-phase components as well as dispersed-phase components on which surface are nucleated a porous transcrystalline layer which pores are filled with amorphous polymer as an amorphous phase.

The Inventor has found and now discloses that subsequent to production of such a microcomposite, it is possible to wash away the isotropic semicrystalline bulk polymer matrix phase together with the polymer crystals that are not associated with dispersed-phase components. As a result, when the dispersed-phase components are nucleating components having a nucleating surface, it is possible to provide a microcomposite comprising one or more microcomposite units, wherein each microcomposite unit includes at least one nucleating component having a nucleating surface; and nucleated from the nucleating surface, a porous transcrystalline layer of a crystallizable thermoplastic polymer, wherein the microcomposite is substantially devoid of a bulk polymer matrix phase in the volume outside of the transcrystalline layer. Further, the microcomposite is substantially devoid of polymer crystals that are not nucleated from the nucleating surface. As such, the outer surface of the transcrystalline layer is exposed, for example, to a gas if the microcomposite is held in a gaseous atmosphere.

In some embodiments, the lack of bulk polymer matrix phase indicating that a microcomposite is substantially devoid of bulk polymer matrix phase in the volume outside of the transcrystalline layer is determined by examining a Scanning Electron Microscopy (SEM) image acquired with a magnification of ×2500 at a working distance of 52 mm and acceleration voltage of 5 kV and determining that the image:
includes at least a portion of one or more transcrystalline layers of one or more microcomposite units,
possibly includes at least a portion of one or more nucleation components of one or more microcomposite units (as seen in FIG. 3A, where a transcrystalline layer is broken),
is devoid of any polymer material outside of a transcrystalline layer, and
is devoid of any spherulitic structure.

Transcrystalline layers are recognized in SEM images as appearing in the form of generally parallel and unidirectional lamellar transcrystals oriented outward from a nucleating surface and are seen either face on, edge on or at any angle therebetween or combinations thereof, the unidirectionally-oriented transcrystals in the transcrystalline layer having a first end associated with an underlying nucleation component and a second end at the outer border of the transcrystalline layer. Lamellar transcrystals appear white when viewed directly from above to very light gray when viewed from an angle because the SEM electron beam produces an effect similar to the light and shadow effect by a light beam shone directly or at an angle on a white object. An amorphous polymer or the amorphous phase of a semicrystalline polymer material that is seen to be outside of the transcrystalline layer, appears as a featureless mass and since it is much softer than the polymer crystals (thus causing a weaker SEM electron beam scattering) appears in the SEM image as dark gray to very dark gray.

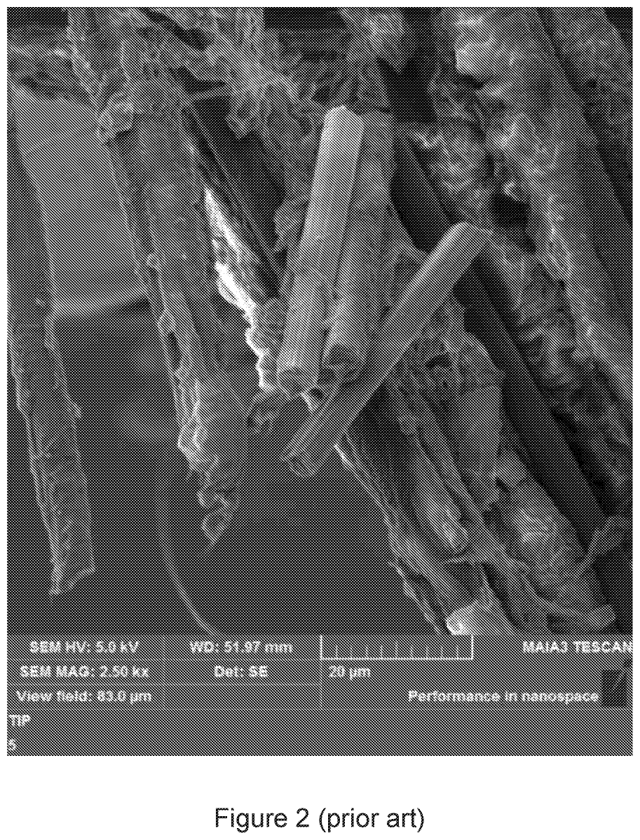

The relatively dark gray shade of a bulk polymer matrix amorphous phase in a SEM image can be seen in FIG. 2, where the surface amorphous phase of the bulk polymer matrix surrounding the carbon fibers is dark gray as opposed to the white to the very-light gray transcrystalline layer crystals seen in FIG. 3 and FIG. 4.

### Physically-Separate Microcomposite Units

The microcomposite according to the teachings herein is substantially devoid of a bulk polymer matrix phase in the volume outside of the transcrystalline layer. In embodiments where a microcomposite comprises at least two microcomposite units, the volume between any two microcomposite units is therefore also substantially devoid of bulk polymer matrix phase that in prior art microcomposites physically connects any two microcomposite units.

In some embodiments comprising at least two microcomposite units, as a result of the volume between the microcomposite units of the microcomposite being substantially devoid of bulk polymer matrix phase, not less than about 30% by weight of the microcomposite units are physically-separable one from the other. In preferred embodiments, not less than about 50%, not less than about 60%, not less than about 70%, not less than about 80%, not less than about 90%, not less than about 95% and even not less than about 97% of the microcomposite units are physically-separable one from the other. In some embodiments, physically separation of the physically-separable microcomposite units is non-destructive, that is to say, no damage is caused to the units on physical separation. Alternatively, in some embodiments, physically separation of the physically-separable microcomposite units causes some damage to the transcrystalline layer as a result of the substantial cohesive forces between the transcrystalline layers of two neighboring microcomposite units.

### Amorphous Thermoplastic Polymer Phase

As discussed above, an inherent consequence of the process by which a porous transcrystalline layer is formed, the pores of the transcrystalline layer are filled with an amorphous thermoplastic polymer.

In some embodiments, removal of the isotropic semicrystalline bulk polymer matrix phase from the volume outside of the transcrystalline layer does not remove or removes only some of the amorphous thermoplastic polymer from the pores of the transcrystalline layer. Accordingly, in some embodiments pores of the porous transcrystalline layer contain amorphous thermoplastic polymer.

It has been found, that if desired, with more intense washing it is possible to remove substantially all of the amorphous thermoplastic polymer from the pores of the porous transcrystalline layer as is seen in FIGS. 3A and 3B. Accordingly, in some embodiments pores of the porous transcrystalline layer are substantially devoid of amorphous thermoplastic polymer.

In some embodiments, the pores of the porous transcrystalline layer being substantially devoid of amorphous thermoplastic polymer is determined by examining a Scanning Electron Microscopy (SEM) image acquired with a magnification of ×2500 at a working distance of 52 mm and acceleration voltage of 5 kV and determining that not less than about 95% of the pores seen in the image from directly above the pore opening (and in some embodiments, not less than about 98%, not less than about 99%, not less than about 99.5% and in some embodiments even not less than about 99.9% of the pores seen in the image from directly above the pore opening) are empty and devoid of amorphous thermoplastic polymer. A pore devoid of amorphous thermoplastic polymer seen in the image from directly above appears completely black while a pore that is at least partially filled with amorphous thermoplastic polymer appears slightly shadowed.

Alternatively, in some embodiments, the pores of the porous transcrystalline layer being substantially devoid of amorphous thermoplastic polymer is determined using Differential Scanning Calorimetry (DSC). In embodiments of the microcomposite according to the teachings herein wherein the pores of the porous transcrystalline layer are substantially devoid of amorphous thermoplastic polymer, the degree of crystallinity of the polymer in a microcomposite is significantly higher than that of the same polymer in a prior art microcomposite. DSC measures the degree of crystallinity of a sample of a microcomposite by determining the enthalpy of melting (ΔH, i.e., delta H) of the sample. The enthalpy of melting is normalized to the weight of only the polymer in the sample, that is to say, subtracting the weight of the nucleating components in the sample. Thus, in some embodiments, the pores of the porous transcrystalline layer being substantially devoid of amorphous thermoplastic polymer is determined by the microcomposite having a degree of crystallinity of not less than about 95% as determined by Differential Scanning Calorimetry, and in some embodiments of not less than about 97% and even not less than about 99% as determined by Differential Scanning Calorimetry, where 0% indicates that the polymer in the sample is non-crystalline and 100% indicates that the polymer in the same sample is completely crystalline.

### Nucleating Component and Nucleating Surface

The nucleating component of a microcomposite according to the teachings herein is any suitable nucleating component having a nucleating surface which is effective in initiating crystallization of a corresponding crystallizable thermoplastic polymer.

### Nucleating Surface

In some embodiments, the entire surface of a nucleating component is a nucleating surface. Alternatively, in some embodiments, only part of the surface of a nucleating component is a nucleating surface.

### Shape of Nucleating Component

The shape of the nucleating component is any suitable shape. In some exemplary embodiments, the nucleating component is selected from the group consisting of a grain, a particle, a crystal, a faceted crystal, a cylinder, a sphere, a plate, a film, a flake, a ribbon or a fiber, although other embodiments include other shapes. It is important to note, that there is some overlap between members of the group so it is possible, for example, that a given nucleating component is both a sphere, a particle and a grain.

In preferred embodiments, the nucleating component is a fiber. As used herein, a fiber is a shape having a cross section with a largest dimension that is not more than about 3 times greater than the smallest dimension of the cross section, and a length perpendicular to cross section which is not less than about 10 times greater than the largest dimension of the cross section. The shape of the cross section of the fiber is any suitable shape, in some embodiments selected from the group consisting of round, oval, dog bone, flat, lobal, polygonal and curved-vertice polygonal. As used herein, the term fiber includes a yarn which is a continuous length of interlocked and intimately associated multiple individual strands.

In some embodiments, the nucleating component is a ribbon. As used herein, a ribbon is a shape having a cross section with a largest dimension that is at least 3 times greater than the smallest dimension of the cross section, and a length perpendicular to cross section which is not less than about 10 times greater than the largest dimension of the cross section. The shape of the cross section of the ribbon is any suitable shape, in some embodiments selected from the group consisting of round, oval, dog bone, flat, lobal, polygonal and curved-vertice polygonal.

In some embodiments, the nucleating component is a flake. As used herein, a flake is a shape having a thickness, a length and a breadth, where the length and the breadth are at least 3 times greater than the thickness, the length is equal to or not more than about 10 times greater than the breadth. The shape of the cross section of the flake perpendicular to the length and the breadth is any suitable shape, in some embodiments selected from the group consisting of round, oval, dog bone, flat, lobal, polygonal and curved-vertice polygonal.

In some embodiments, the nucleating component is a grain. As used herein, a grain is a shape having a greatest height, greatest width and greatest depth which are all within 20% of each other. In some embodiments, one or more of the height, width and depth are regular, e.g., a spherical, a spheroid or rod-shaped grain. In some embodiments, a grain is crystal-shaped. In some embodiments, a grain is irregularly shaped.

In some embodiments, all of the nucleating components of a microcomposite have substantially the same shape. In some alternative embodiments, a microcomposite comprises nucleating components having different shapes.

### Size of Nucleating Component

The dimensions of the nucleating components are any suitable size. In some embodiments, at least one dimension of the nucleating component is not greater than about 1 mm. In some embodiments, at least two dimensions are not greater than about 1 mm.

In some preferred embodiments, at least one of the dimensions of the nucleating components are not less than about 1 nanometer and not more than about 100 micrometers.

In some preferred embodiments, all of the dimensions of the nucleating components are not less than about 1 nanometer and not more than about 100 micrometers.

In some embodiments where the nucleating component is a fiber or a ribbon, the cross sectional area of the fiber or the ribbon is between about 1 micrometer 2 and about 25 mm² . Alternatively, in some preferred embodiments where the nucleating component is a fiber or a ribbon, the cross sectional area of the fiber or the ribbon is not less than about 1 nanometer² and not more than about 40000 micrometer² and the length of the fiber is not less than about 10 nanometers and not more than about 1000 meters.

In some preferred embodiments where the nucleating component is a nanofiber (e.g., a clay or mineral nanofiber), the cross sectional area of the nanofiber is not less than about 1 nm² and not more than about 10 micrometer² and the length of the nanofiber is not less than about 10 nanometers and not more than about 100 micrometers.

In some preferred embodiments where the nucleating component is a carbon fiber, the cross sectional area of the carbon fiber is not less than about 0.01 micrometer² and not more than about 100 micrometer² and the length of the carbon fiber is not less than about 10 and not more than about 1000 micrometers.

In some embodiments, all of the nucleating components of a microcomposite have substantially the same size. In some alternative embodiments, a microcomposite comprises nucleating components having different sizes.

For example, in some embodiments where the nucleating component is a fiber, all of the fibers have the same cross sectional area, e.g., for round fibers have the same diameter. Alternatively, in some such embodiments, the fibers have different cross sectional areas.

Additionally or alternatively, in some embodiments where the nucleating component is a fiber, all of the fibers have the same length. Alternatively, in some embodiments, the fibers have different lengths.

### Material of the Nucleating Surface

The nucleating surface of the nucleating component is any suitable surface which during the process of making the microcomposite qualitatively speaking, encourages early, quick and dense transcrystallization of the crystallizable fraction a molten thermoplastic polymer.

A person having ordinary skill in the art of polymer crystallization is able to select, for any given thermoplastic polymer a suitable nucleating surface. Depending on the embodiment, the nucleating surface can be of any chemical composition and of any source, non-limiting examples include a mineral, an organic material, a polymer, a biologic material, an electrically-conducting polymer, a ceramic material, a metal, an electrically-conducting or semi-conducting material, a sintered powder, a medicine, a catalyst, a semiconductor, a sensor.

In some embodiments, the nucleating component is of a material selected from the group consisting of a polymer, a non-polymer, a metal, a ceramic, a natural fiber, cellulose, a polysaccharide, a protein, an electrically-conductive material, a bi-component material, a hollow fiber, a nanofiber and an electro-spun fiber.

A particularly suitable nucleating component is a component of carbon (e.g., a crystalline carbon such as graphite or graphene), especially a carbon fiber, as carbon has an inherently suitable nucleating surface. In some preferred embodiments where the nucleating component is a carbon fiber, the fibers having a diameter of not less than about 1 micrometer and not more than about 10 micrometers.

In some embodiments, a nucleating component material with an inherently-suitable nucleating surface is a natural material, such as cotton, silk, wool, linen and hemp, preferably as a fiber.

In some embodiments, a nucleating component material with an inherently-suitable nucleating surface is a polymer that is crystalline, semicrystalline or amorphous, for example ultrahigh molecular weight polyethylene (UHMWPE), polypropylene, aramid (e.g., Kevlar® or Twaron®), polyesters and polyamides (e.g., nylon), preferably as a fiber.

In some embodiments, a nucleating component material with an inherently-suitable nucleating surface is a non-polymer material such as a metal, a ceramic (e.g., SiC), boron, glass or mineral, preferably as a fiber.

In some embodiments, a nucleating component is made of a material which undergoes a surface treatment or coating that renders the surface more suitable as a nucleating surface. In some embodiments, a suitable surface treatment is selected from the group consisting of coating, chemical modification such as CVD, chemical derivatization, physical modification such as PVD, plasma treatment, etching and combinations thereof.

In preferred embodiments, all of the nucleating surfaces of all of the nucleating components are substantially the same. In some alternative embodiments, there are at least two substantially different nucleating surfaces.

### Transcrystalline Layer of Crystallizable Thermoplastic Polymer

In a microcomposite according to the teachings herein, the transcrystalline layer is made of any suitable thermoplastic polymer.

In some embodiments, the crystallizable thermoplastic polymer is selected from the group consisting of a copolymer, a block-copolymer, a homopolymer, an oligomer, a branched polymer, a grafted polymer, a synthetic polymer, a natural polymer, a modified natural polymer, a denaturated natural polymer, degradation-derived fractions of a natural and/or a synthetic polymer, a degradable polymer, an electrically conductive polymer, a polymer with chemically and/or physically bonded active agent/molecule and/or drug, a polymer with chemically and/or physically bonded electrically, catalytically and/or optically active molecule and/or atom and combinations thereof.

In some embodiments, the crystallizable thermoplastic polymer is selected from the group consisting of a polyester, a polyamide, a polypeptide, a polyimide, a polyether, a poly (ether ether ketone), a polyolefin, an unsaturated polyolefin, a polysulfone, a polysaccharide, an acrylic polymer, a polysiloxane, a polyanhydride, a polyurethane, a polyurea, a poly(ether urethane), a poly(ether urethane amide), a poly(ester urethane), a poly(ether urethane urea) and combinations thereof.

In some preferred embodiments, the crystallizable thermoplastic polymer is selected from the group consisting of polyethylene, polypropylene, polyester and polyamide. In some preferred embodiments, the crystallizable thermoplastic polymer is high-density polyethylene (HDPE).

As noted above, a microcomposite according to the teachings herein comprises a porous transcrystalline layer of a crystallizable thermoplastic polymer nucleated from the nucleating surface of a nucleating component.

A transcrystalline layer of a crystallizable thermoplastic polymer is a continuous collection of polymer crystals that grow and extend unidirectionally outwards from a nucleating surface, or radially outwards from a fiber surface (the fiber being of approximately circular cross-section) in a continuous ordered structure that covers the nucleating surface or encases the fiber.

In preferred embodiments, the porous transcrystalline layer has an open-cell morphology with interconnected-voids from the fiber surface to the outer surface of the microcomposite unit. The voids (i.e. the pores) are an integral part of the transcrystalline structure (as a result of the amorphous phase removal) and do not cause a gap or interruption in the continuity of the transcrystalline layer. The void fraction resulting from the pores of the transcrystalline layer is any suitable void fraction, preferably greater than about 50%, i.e., more than about 50% of the volume of the transcrystalline layer is void and less than about 50% of the volume of the transcrystalline layer is polymer.

Typically, the transcrystalline layer has a consistently-increasing pores size, with pores close to the nucleating surface being comparatively small, with pore size progressively increasing with distance from the nucleating surface so that the pores furthest from the nucleating surface being comparatively large.

The thickness of the transcrystalline layer is any suitable thickness. As used herein, the thickness of the transcrystalline layer is the distance from the nucleating surface to where 95% of the transcrystalline layer associated with the nucleating surface ends. In preferred embodiments, the transcrystalline layer is not less than about 0.1 micrometers and not more than about 200 micrometers thick.

In some embodiments where the nucleating component is a single fiber, all of the diameters of a given microcomposite unit are within 10% of the average diameter of the microcomposite unit.

In some embodiments, where the nucleating component is a single fiber, the outer diameter of the transcrystalline layer is at least about twice and not more than about 10 times the diameter of the encased fiber.

In some embodiments, the transcrystalline layer constitutes not less than about 90% by volume of the corresponding microcomposite unit (equivalent to a transcrystalline layer dimension/nucleating component dimension of 3.1:1, e.g., a nucleating fiber with a radius X and a transcrystalline layer having a radius 3.1 X). In preferred embodiments, the transcrystalline layer constitutes not less than about 95% (4.5:1), not less than about 98% (7:1), not less than about 99% (10:1), even not less than about 99.5% (14:1) and even not less than 99.9% (26:1) by volume of the microcomposite unit. In some embodiments, the relative volume of the transcrystalline layer is determined by Scanning Electron Microscopy (SEM) with a magnification of ×2500 at working distance of 52 mm and acceleration voltage of 5 kV.

### Superhydrophobicity

In some embodiments, the surface of a microcomposite according to the teachings herein is superhydrophobic, Specifically, in such embodiments, the contact angle of a water droplet on the surface of a macroscopic mass of microcomposite that is made up of one or more microcomposite units is greater than 150°.

### Products Comprising a Microcomposite of the Teachings Herein

According to an aspect of some embodiments of the teachings herein, there is provided a product comprising a microcomposite according to the teachings herein.

As discussed above, after a microcomposite according to teachings herein is made the pores of the transcrystalline layer of the microcomposite units are substantially empty. In some embodiments, the pores of the transcrystalline layer subsequently undergo a physical treatment to change the surface properties thereof, for example, cold plasma treatment. Additionally or alternatively, in some embodiments, the pores of the transcrystalline layer are subsequently at least partially filled with a material. For example, in some embodiments, a microcomposite is further processed by partial or total nanocoating and/or filling and/or combining with conducting and/or semi-conducting materials for the microelectronics industry and for the communication/telecommunication industry.

Alternatively, in some embodiments, the product is a composite material having a continuous matrix phase and a dispersed phase, the dispersed phase comprising (and even consisting) of a microcomposite according to the teachings herein. In some such embodiments, the dispersed phase at least partially fills the pores of the transcrystalline layer. In some such embodiments, the bonding between the dispersed phase and the matrix phase is particularly robust, presumably due to the presence of the large surface area of the transcrystalline layer.

In some embodiments, the microcomposite of the teachings herein is a component in a product selected from the group consisting of a microelectronics device, an artificial implant, an artificial tissue, a controlled delivery system, a medicament, a biofilm, a membrane, a filter, a chromatography column, a size-exclusion column, an ion exchange column, a catalyst, a nano-scaffold, a micro-robot, a micro-machine, a nano-machine, a processor, an optical device, a molecular sieve, a detector, an adsorbing material, a substrate, a nucleant, a nano-reactor, a mechanical component, a friction coefficient reducer or enhancer, a metamaterial, or combinations thereof.

In some embodiments, the microcomposite of the teachings herein is a component in a product (e.g., an object, a material, a device) that exhibits a very high specific surface area, characteristic of nanomaterials.

In some embodiments, the microcomposite of the teachings herein is a component in a product (e.g., an object, a material, a device) for use as an artificial implant and/or as a tissue engineering nanoscaffold, for example in the biomedical industry and for efficient substrate-adhesion of biofilms in the biotechnology industry.

### Methods of Making a Microcomposite

A microcomposite according to the teachings herein can be made in any suitable fashion. In preferred embodiments, a microcomposite is made according to the method of the teachings herein, According to an aspect of some embodiments of the teachings herein, there also provided a method of manufacturing a microcomposite (in preferred embodiments, a microcomposite as described herein), comprising:
a. providing a melt that comprises a chosen crystallizable thermoplastic polymer, the melt being at a first temperature;
b. providing at least one nucleating component having a nucleating surface;
c. subsequent to ‘a’ and ‘b’, intimately contacting at least part of the nucleating surface of the at least one nucleating component with the melt;
d. subsequent to ‘c’, lowering the temperature of the melt that is in intimate contact with the part of the nucleating surface to a second empirically-predetermined isothermal temperature, lower than the first temperature, at which a transcrystalline layer is nucleated and formed on the nucleating surface intimately contacting the melt and no crystallization occurs in the bulk matrix melt beyond the transcrystalline layer, thereby making an incipient microcomposite comprising the formed transcrystalline layer nucleated on the nucleating surface where pores of the transcrystalline layer are filled with an amorphous polymer phase and bulk polymer matrix melt is outside of the transcrystalline layer;
e. subsequent to ‘d’, when the transcrystalline layer that is formed on portions of the nucleating surface is of a desired thickness and/or has stopped growing, immersing the nucleating surface, the formed transcrystalline layer and bulk polymer matrix melt that is adhered thereto in an extraction solvent suitable for extracting the chosen thermoplastic polymer, so as to remove substantially all of the adhered bulk polymer matrix melt from the outside of the formed transcrystalline layer of the incipient microcomposite, thereby making a microcomposite comprising at least one microcomposite unit that includes at least one nucleating component having a nucleating surface; and nucleated from the nucleating surface, a porous transcrystalline layer of crystallizable thermoplastic polymer, wherein the made microcomposite is substantially devoid of a bulk polymer matrix phase in the volume outside of the porous transcrystalline layer; and
f. removing the microcomposite from immersion in the extraction solvent.

Details such as the identity, dimensions and other parameters of the nucleating component, the nucleating surface and the crystallizable thermoplastic polymer are as described above, mutatis mutandi, with reference to the microcomposite according to the teachings herein and are not repeated here for brevity.

In some embodiments, subsequently to ‘f’, the method further comprises removing any extraction solvent from the microcomposite, In some such embodiments, removing the extraction solvent is by blotting the surface of the made microcomposite with an absorbant material.

In some embodiments, the immersing ‘e’ of the nucleating surface and the formed transcrystalline layer in the extraction solvent is sufficient to remove substantially all of the amorphous polymer phase from the pores of the transcrystalline layer.

In some embodiments, the entire surface of the nucleating component is intimately contacted with the melt. In some alternative embodiments, only a portion of the surface of the nucleating component is intimately contacted with the melt.

In some embodiments, the intimately contacting ‘c’ at least part of the nucleating surface of the at least one nucleating component with the melt comprises at least partially immersing the at least one nucleating component in the melt so that at least a portion of the nucleating surface is in intimate contact with the melt.

Alternatively, in some embodiments the intimately contacting ‘c’ at least part of the nucleating surface of the at least one nucleating component with the melt comprises coating at least a portion of the nucleating surface with the melt so that the nucleating surface is in intimate contact with the melt.

The immersing in the extraction solvent ‘e’ is performed after a time at any suitable stage of transcrystalline growth. Typically, the time is empirically-predetermined.

In some embodiments, the melt comprises, in addition to the crystallizable thermoplastic polymer a chosen amount of an additive:
the additive being a liquid under the crystallization conditions of the crystallizable thermoplastic polymer from the melt;
the additive being miscible with the crystallizable thermoplastic polymer in the melt so that the melt is homogeneous; and
the additive does not phase-separate from the melt.

A typical suitable additive for polyolefins such as polyethylene and polypropylene is is paraffin oil.

In some embodiments, during the intimately contacting of at least part of the nucleating surface of the at least one nucleating component with the melt, the nucleating component is in contact with a substrate or a support. In some embodiments, the substrate or support is a component of a final product.

A number of specific embodiments of the method are described in greater detail below.

### Method Embodiment 1

a. Melting a selected crystallizable thermoplastic polymer to provide a melt, for example in a bath.
b. Providing at least one fiber as a nucleating component which outer surface is the nucleating surface.
c. Coating the at least one fiber with the melt by immersion in the melt, for example, in a bath holding the melt.
d. Cooling the melt-coated at least one fiber to initiate nucleation on the nucleating surface and subsequent crystallization of the thermoplastic polymer, to form an incipient microcomposite including a porous transcrystalline layer that encases the fiber(s). For example, cooling is performed by removing the at least one fiber from the melt bath and letting cool in ambient air.
e. When desired (e.g., at or prior to complete crystallization of the transcrystalline phase in ‘d’) immersing the incipient microcomposite in a bath containing the chosen extraction solvent and extracting all of the bulk polymer matrix phase in the volume outside of the porous transcrystalline layer and, optionally, also the amorphous polymer in the pores of the transcrystalline layer.
f. Subsequent to ‘e’, removal of the resulting microcomposite from the extraction solvent.
g. Removing residual solvent from the microcomposite of ‘f’, preferably by blotting.

In such embodiments where the nucleating component is a single fiber, or multiple mutually-contacting fibers, a microcomposite that is a single microcomposite unit is made.

### Method Embodiment 2

Substantially similar to Method Embodiment 1, but in ‘d’, the melt-coated at least one fiber is cooled to and maintained at a chosen isothermal temperature, that is experimentally-found to be suitable for the nucleation and growth of only the porous transcrystalline layer and not of crystals in the surrounding bulk melt. Preferably, all the other steps of Method Embodiment 1 remain the same. Cooling and maintaining at a chosen isothermal temperature may be in the melt bath or may be in a separate temperature-controlled crystallization oven.

### Method Embodiment 3

Substantially similar to Method Embodiments 1 and 2 but the melt comprises in addition to the crystallizable thermoplastic polymer a chosen amount of at least one additive, the additive being a liquid under the crystallization conditions of the crystallizable thermoplastic polymer from the melt; the additive being miscible with the crystallizable thermoplastic polymer in the melt so that the melt is homogeneous; and the additive does not phase-separate from the melt. A typical suitable additive is paraffin oil.

### Method Embodiment 4

Substantially similar to Method Embodiments 1, 2 and 3 where:
i. subsequent to ‘a’ and prior to ‘c’, the melt is spread on a substrate or support (of any suitable material, size and shape) such as a tray
ii. in ‘c’, laying at least one fiber on the substrate or support so that the at least one fiber is partially (partial length and/or partial cross section) or completely in intimate contact with the melt on the support.
iii. in ‘d’ immersing the coated at least one fiber in a bath containing the chosen extraction solvent together with the substrate or support.
iv. at the end, the substrate or support may be part of the final product.

### Method Embodiment 5

Substantially similar to Method Embodiments 1, 2, 3 and 4 where the nucleating component is multiple fibers arranged in some predetermined way prior to intimate contact with the melt. Examples include: with no contact, contacting at one intersection point, parallel, stretched, oriented, aligned, intersecting, woven, knitted, at random, or any suitable combination thereof.

### Method Embodiment 6

Substantially similar to Method Embodiments 1, 2, 3, 4 and 5 where one or more of:
i. One or more nucleating component have a shape other than a fiber, as listed hereinabove or selected from the group consisting of powders, particles, spheres, cylinders, plates, films, cubes, pyramids, polyhedra, porous materials, or any combination thereof.
ii. The microcomposite includes multiple nucleating component including at least one fiber and at least one non-fiber having a shape other than a fiber, as listed hereinabove or selected from the group consisting of powders, particles, spheres, cylinders, plates, films, cubes, pyramids, polyhedra, porous materials, or any combination thereof.
iii. The non-fiber nucleating component(s) of i or ii are any chosen material, for example selected from the group consisting of crystalline, semicrystalline, or amorphous, non-limiting examples of which are: metals, minerals, ceramic materials, organic materials, inorganic materials, glasses, materials of biological origin, electrically conductive materials, electrically non-conductive materials, polymers, or any combination thereof.

The method according to the teachings herein provide a microcomposite according to the teachings herein comprising nucleating components partially or totally encased in a transcrystalline layer devoid of of a bulk polymer matrix phase in the volume outside of the porous transcrystalline layer and in some embodiments also devoid of amorphous thermoplastic polymer phase in the pores of the transcrystalline layer.

Without wishing to be held to any one theory, it is currently known (see hereby cited references) that a transcrystalline layer forms on the nucleating surface of the nucleating components by the crystallization of crystallizable thermoplastic polymer fractions in the melt, nucleating from the nucleating surface of the nucleating components and proceeding outwards. During the crystallization process, i.e., after the transcrystalline crystallization process starts but before or at complete crystallization of the transcrystalline layer that encases nucleating components, the nucleating components covered with the melt and the transcrystalline layer is immersed in an extraction solvent, under any chosen condition of time and temperature, for extracting all of the bulk polymer matrix phase in the volume outside of the transcrystalline layer and in some embodiments extracting some or all of the amorphous polymer phase found in the pores of the transcrystalline layer in a manner analogous to the amorphous phase extraction method described in US 2020/0165405 which is included by reference as if fully set-forth herein for the purpose of providing an enabling description for such extraction.

The transcrystalline layer crystallization period is characterized by: a crystallization start time, defined as a time when a first polymer crystal is nucleated on the nucleating surface; a crystallization end time, defined as characterized by a time when a last crystal stops growing in the transcrystalline layer and no additional crystals are formed in the transcrystalline layer; and a transcrystallization kinetics period tₖₜ, defined as a duration beginning at the transcrystallization start time and ending at the transcrystallization end time, and wherein the contacting with the extraction solvent is performed at a time of between about 0.01 tₖₜ and about tₖₜ after the crystallization start time.

### Coating Fibers

In some embodiments, the at least one nucleating component is contacted with the melt by immersing the at least one nucleating component in the melt.

In some embodiments, the at least one nucleating component is contacted with the melt by partially or totally embedding the at least one nucleating component in a layer of the melt spread or coated on at least part of a support or substrate of any chosen material, size and shape.

In some embodiments, the at least one nucleating component is contacted with the melt by placing the at least one nucleating component in a flow of the melt.

### Molding a Transcrystalline Layer

As known in the art, a transcrystalline layer is typically anisotropic, oriented outward from the nucleating surface. In some embodiments, the transcrystalline layer of a microcomposite unit is radially symmetrical and has a circular cross-section.

In some embodiments, the transcrystalline layer of a microcomposite according to the teachings herein is the result of epitaxial growth of the constituent crystals, on the nucleating surface.

In some alternate embodiments, the at least one nucleating component while in intimate contact with the melt is maintained inside a mold having dimensions in the order of a transcrystalline phase, i.e., less than about 5000 micrometers, in some embodiments less than about 1000 micrometers and even less than about 100 micrometers. As a result, the transcrystalline layer grows outwards but, in some directions, encounters the mold wall and stops growing so that ultimately the transcrystalline layer has an outer periphery that is shaped by the shape of the mold.

Such a mold is of any suitable material, e.g., glass, metal, polymer, ceramic, composite, an electrically-conductive materials, an electrically semi-conductive material, an insulating material, a materials of biological origin and/or combinations thereof.

In some embodiments, the mold is immersed in the extraction solvent together with the at least one nucleating component.

In some embodiments, the final product includes the mold physically-associated with the microcomposite.

### Solvent Extraction

In some embodiments, contacting of an incipient microcomposite with the extraction solvent is performed when polymer crystallization to form lamellar polymer crystals has occurred beyond the boundaries of the transcrystalline layer. In such embodiments, an incipient microcomposite may include some lamellar-crystallized polymer attached or adjacent to the outside of the transcrystalline layer.

In some embodiments, immersion of the incipient microcomposite in the extraction solvent is performed when no or only minimal polymer crystallization has occurred beyond the boundaries of the transcrystalline layer. As described above, this is achieved by immersing the incipient microcomposite in the extraction solvent at, or before the end of the crystallization period of the transcrystalline layer (before significant crystallization occurs in the bulk matrix).

For example, some crystallizable thermoplastic polymers such as HDPE are transparent when melted but opaque/translucent when crystalline. In embodiments where the crystallizable thermoplastic polymers is HDPE, immersion of the incipient microcomposite in an extraction solvent during partial crystallization can be performed by optical (visual) monitoring the decrease in transparency of the melt during the crystallization process and initiating the extraction process at a chosen instant of the partial crystallization process. Alternatively, this can be also achieved by other means of crystallization process monitoring, such as polarized light microscopy.

As a result, in some embodiments when a microcomposite of the teachings herein is formed, the microcomposite comprises a single microcomposite unit that is a single fiber encased in a polymeric crystalline thermoplastic nanostructured porous transcrystalline layer that is devoid of bulk polymer matrix phase as well as amorphous phase as described above.

### Solvent Removal

Subsequent to removal of the microcomposite from immersion in the solvent, residual solvent is removed from the microcomposite units. Such solvent removing is performed in any suitable way, preferably in a matter different from solvent evaporation, for example by centrifugation and/or blotting.

### Long Microcomposite Unit

In some preferred embodiment the at least one nucleating component of a single microcomposite unit are long and continuous fiber(s), ribbon(s) or the like that is/are drawn through a series of stations to perform the method in a continuous (rather than batch) process:
a coating station from which the uncoated at least one nucleating component is provided, a following station for coating the at least one nucleating component with a melt, for example, by immersion in a bath of melt (e.g., a melt of molten thermoplastic polymer or molten thermoplastic polymer-additive mixture);
following the coating station a crystallizing station for lowering the melt temperature for crystallizing the crystallizable components of the polymer in the melt to form an incipient microcomposite with a transcrystalline layer nucleated on the nucleating surface of the at least one nucleating component;
following the crystallizing station, an extraction station for contacting the incipient microcomposite with an extraction solvent for extraction of some or all of the polymer that is not part of the transcrystalline layer; and
following the extraction station, a solvent-removal station for removal of residual solvent, preferably by blotting.

In some such embodiments, one or more of the stations taken together constitute an inventive device according to the teachings herein.

In such embodiments, a thus-formed microcomposite is a continuous long microcomposite strand. In some embodiments, the strand is not less than about 10 cm long, not less than about 30 cm long and even not less than about 100 cm long.

### Polymer

As discussed above, a provided polymer is any suitable crystallizable thermoplastic polymer.

In some embodiments, the polymer is selected from the group consisting of thermoplastic polymer, a copolymer, a block-copolymer, a homopolymer, an oligomer, a branched polymer, a grafted polymer, a synthetic polymer, a natural polymer, a modified natural polymer, a denaturated natural polymer, degradation-derived fractions of a natural and/or a synthetic polymer, a degradable polymer, an electrically conductive polymer, a polymer with chemically and/or physically bonded active agent/molecule and/or drug, a polymer with chemically and/or physically bonded electrically, catalytically and/or optically active molecule and/or atom and combinations thereof.

In some embodiments, the polymer is selected from the group consisting of a polyester, a polyamide, a polypeptide, a polyimide, a polyether, a poly (ether ether ketone), a polyolefin, an unsaturated polyolefin, a polysulfone, a polysaccharide, an acrylic polymer, a polysiloxane, a polyanhydride, a polyurethane, a polyurea, a poly(ether urethane), a poly(ether urethane amide), a poly(ester urethane), a poly(ether urethane urea) and combinations thereof.

In some embodiments, the polymer is selected from the group consisting of polyethylene, polypropylene, polyester or polyamide.

Melt with/without Additives

In some embodiments, the melt is a pure thermoplastic polymer, that is to say, at least about 99% and in some embodiments at least 99.9% by weight of a single thermoplastic polymer.

Alternatively, in some preferred embodiments additive or additives constitute at least 0.1% and not more than 80% by weight of the melt, preferably the balance being thermoplastic polymer. The additive or additives can be a polymer or a non-polymer or a combination thereof. Such an additive is or additives are chosen to be a liquid under the crystallization conditions of the thermoplastic polymer and/or in combination/blend with the molten thermoplastic polymer and that does not phase separate from the polymer melt.

Non-limiting examples of additives include low-molecular-weight synthetic polymers, low-molecular-weight natural polymers, fractioned polymers, branched polymers, dendrimers, essential oils, paraffin oils, oligomers, oils, non-volatile liquid organic compounds, non-volatile solvents, non-volatile liquid inorganic compounds, surfactants, detergents, slip agents, organic dyes, plasticizers, phthalates, wetting agents and combinations thereof.

### Fiber Nucleating Component

In preferred embodiments, the nucleating component is a fiber, ribbon or similar.

Preferably, such a nucleating component is isolated, that is to say, it is physically separated and not contacting other nucleating components, In some embodiments, the nucleating component is continuous. Alternatively, in some embodiments, the nucleating component is not-continuous.

In some embodiments, the nucleating component is a non-polymer material such as a non-polymer fiber.

Alternatively, in some embodiments, the nucleating component is a polymer material such as a polymer fiber. In some embodiments, the nucleating component is a surface-modified polymer or non-polymer nucleating component, e.g. by coating, chemical modification such as CVD, physical modification such as PVD, plasma treated, etched and combinations thereof. In some such embodiments, the nucleating component is an amorphous polymer or non-polymer nucleating component. Alternatively, in some embodiments, the nucleating component is a semi-crystalline polymer nucleating component. Alternatively, in some embodiments, the nucleating component is a crystalline polymer nucleating component. In some embodiments, the nucleating component is a hollow polymer fiber.

### Use of a Microcomposite According to the Teachings Herein

One particular use of the microcomposites of the teachings herein are as transcrystalline microcomposite fibers for the manufacture of textiles with novel properties and applications, such as for example: smart textiles, thermal textiles, thermally-insulating textiles, textiles with medical applications.

One use of the microcomposites of the teachings herein are as reinforcing fibers for the manufacture of fiber-reinforced composites. Due to the superior bonding between the outer surface of the microcomposite and the bulk polymer (due to large diameter of the microcomposite, porosity of the outer surface and in some embodiments, chemical similarity), the superior strength of the transcrystalline phase and the superior bonding of the transcrystalline phase to the central fiber, such a composite may have surprisingly superior mechanical properties.

In some embodiments, a microcomposite according to the teachings herein, serves as a component in an object selected from: a microelectronic device, an artificial implant, an artificial tissue, a controlled delivery system, a medicament, a biofilm, a membrane, a filter, a chromatography column, a size-exclusion column, an ion exchange column, a catalyst, a nano-scaffold, a micro-robot, a micro-machine, a nano-machine, a processor, an optical device, a molecular sieve, a detector, an adsorbing material, a substrate, a nucleant, a nano-reactor, a mechanical component, a friction coefficient reducer or enhancer, a metamaterial, or combinations thereof.

Embodiments of microcomposites made in accordance with the teachings herein are useful, for example, for: partial or total nanocoating and/or filling and/or combining with conducting and/or semi-conducting materials in the microelectronics industry and for the communication/telecommunication industry; artificial implants and tissue engineering nanoscafolds in the biomedical industry; and for efficient substrate-adhesion of biofilms in the biotechnology industry; a material or device exhibiting very high specific surface area, characteristic of nanomaterials; and as a material or device exhibiting super-hydrophobic surface properties.

### EXPERIMENTAL

Carbon fibers, reagents and solvents were purchased from a commercial source. High-density polyethylene (HDPE) was acquired from a commercial source (HDPE Sclair 2909, Du-Pont).

### Example 1 (Prior Art)

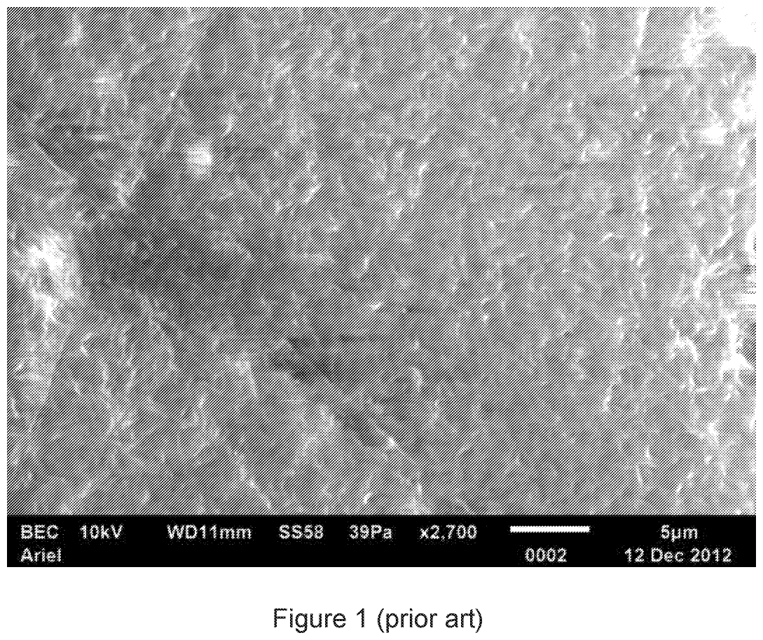

An amount of 100 mg of the HDPE polymer was melted on a first clean glass slide, by placing it on a heating plate, and kept at above its melting temperature (about 132° C.) at approximately 150° C. for 2 minutes in order to erase crystalline memory. The HDPE polymer melt was manually shaped in a form of a film on the first glass slide, by pressing a second clean glass slide on top of it, while on the heating source. The two glass slides with the HDPE polymer melt therebetween were removed from the heating source and complete crystallization of the polymer melt was performed by air-cooling at room temperature (about 30° C.). The thickness of the film obtained was approximately 20-25 μm. An image of the surface of the sheet was acquired using a scanning electron microscope, see FIG. 1.

### Example 2 (Prior Art)

HDPE-carbon fibers untreated control microcomposite film was made by melting approximately 100 mg of polymer and spreading it on the surface of a glass slide, followed by manually embedding approximately 10-15 separate carbon fibers (cut and separated from a commercial carbon fiber yarn) in the molten HDPE polymer, inducing crystallization in the matrix and growth thereof by cooling at room temperature. An image of the surface of the sheet was acquired using a scanning electron microscope, see FIG. 2.

### Example 3

Microcomposite units of the teaching herein, each comprising a single carbon fiber encased in a nanoporous transcrystalline layer, devoid of amorphous phase were obtained by the following procedure: Approximately 50 mg of HDPE (the same HDPE as in Examples 1 and 2 was melted on a glass slide support, placed on a heating plate at about 150° C. The HDPE polymer melt was mixed on the glass slide on the heating plate with a chosen amount of a chosen amorphous liquid additive (paraffin oil, USP grade, Merck), to obtain a homogeneous slurry. The mixing ratio in this case was approximately 3:1 paraffin: polymer. The molten mixture was spread on the glass slide and followed by manually embedding approximately 15 separate carbon fibers (cut and separated from a commercial spool of carbon fiber yarn) in the molten HDPE polymer mixture.

The slide was removed from the heating plate and partial crystallization of the polymer melt was performed by air-cooling at room temperature (about 30° C.) and then immersed in an ice-cooled appropriate extraction solvent (xylene, analytical, Sigma), under mild manual agitation, for a period of about 15-20 seconds. The slide was then removed from the solvent and blotted with several blotting papers.

The solvent immersion instant was aimed at, or before the end of the crystallization period of the transcrystalline layer (before significant crystallization occurs in the bulk matrix).

The transcrystalline crystallization period is characterized by: a crystallization start time, defined as a time when a first polymer crystal is nucleated on the fiber surface (or on any other geometry of the heterogeneous nucleating surface); a crystallization end time, defined as characterized by a time when a last crystal stops growing in the transcrystalline layer and no additional crystals are formed in the transcrystalline layer; and a crystallization kinetics period tₖₜ, defined as a duration beginning at the crystallization start time and ending at the crystallization end time, and wherein the immersing is executed at a time of between about 0.01 tₖₜ and about tₖₜ after the crystallization start time.

Monitoring of the crystallization process was performed visually: HDPE polymer melt is transparent, whereas crystalline HDPE is opaque. Partial crystallization was assessed by optically (visual) monitoring the decrease in transparency of the HDPE melt in different regions of the sample during the crystallization process and initiating the extraction process at a chosen instant of the partial crystallization process.

In the present experiments, the carbon fibers were manually embedded in the melt and not simply coated with the melt, due to the fact that the carbon fibers are very thin and highly brittle, thus attempts to perform manual handling and coating of the individual carbon fibers resulted in multiple breakage of the brittle carbon fibers. In industrial processing, continuous coating of the carbon fibers can be implemented.

An image of the microcomposites was acquired using a scanning electron microscope, see FIGS. 3A and 3B.

The fact that the microcomposite units are devoid of amorphous polymer was confirmed, as no amorphous polymer is observed by Scanning Electron Microscopy (SEM) with a magnification of ×2500 at working distance of 52 mm and acceleration voltage of 5 kV.

Unless otherwise defined, all technical and scientific terms used herein have the same meaning as commonly understood by one of ordinary skill in the art to which the invention pertains. In case of conflict, the specification, including definitions, takes precedence.

As used herein, the terms “comprising”, “including”, “having” and grammatical variants thereof are to be taken as specifying the stated features, integers, steps or components but do not preclude the addition of one or more additional features, integers, steps, components or groups thereof. As used herein, the indefinite articles “a” and “an” mean “at least one” or “one or more” unless the context clearly dictates otherwise. As used herein, when a numerical value is preceded by the term “about”, the term “about” is intended to indicate +/−10%. As used herein, a phrase in the form “A and/or B” means a selection from the group consisting of (A), (B) or (A and B). As used herein, a phrase in the form “at least one of A, B and C” means a selection from the group consisting of (A), (B), (C), (A and B), (A and C), (B and C) or (A and B and C).

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the scope of the appended claims.

Citation or identification of any reference in this application shall not be construed as an admission that such reference is available as prior art to the invention.

Section headings are used herein to ease understanding of the specification and should not be construed as necessarily limiting.

1. A microcomposite comprising one or more microcomposite units, wherein each microcomposite unit includes:
at least one nucleating component having a nucleating surface; and
nucleated from said nucleating surface, a porous transcrystalline layer of crystallizable thermoplastic polymer,
wherein the microcomposite is substantially devoid of a bulk polymer matrix phase in the volume outside of said porous transcrystalline layer, and is devoid of any spherulitic structure.

2. The microcomposite of claim 1, wherein said lack of bulk polymer matrix phase is determined by examination of a Scanning Electron Microscopy (SEM) image acquired with a magnification of ×2500 at a working distance of 52 mm and acceleration voltage of 5 kV and determining that the image:
includes at least a portion of one or more transcrystalline layers of one or more microcomposite units,
possibly includes at least a portion of one or more nucleation components of one or more microcomposite units,
is devoid of any polymer material outside of a transcrystalline layer, and
is devoid of any spherulitic structure.

3. The microcomposite of claim 1, wherein pores of said porous transcrystalline layer contain amorphous thermoplastic polymer.

4. The microcomposite of claim 1, wherein the pores of said porous transcrystalline layer are substantially devoid of amorphous polymer.

5. The microcomposite of claim 4, wherein said pores of said porous transcrystalline layer being substantially devoid of amorphous polymer is determined by examination of a Scanning Electron Microscopy (SEM) image acquired with a magnification of ×2500 at a working distance of 52 mm and acceleration voltage of 5 kV and determining that not less than about 95% of the pores seen in the image from directly above the pore opening are empty and devoid of amorphous thermoplastic polymer.

6. The microcomposite of claim 4, wherein said pores of said porous transcrystalline layer being substantially devoid of amorphous thermoplastic polymer is determined by said microcomposite having a degree of crystallinity of not less than about 95% as determined by Differential Scanning Calorimetry (DSC) using a heating rate of 10° C./minute.

7. The microcomposite of claim 1, wherein said at least one nucleating component is a small number greater than one of individual nucleating components.

8. The microcomposite of claim 1, wherein said at least one nucleating component is a single nucleating component.

9. The microcomposite of claim 1, comprising at least two said microcomposite units, wherein not less than about 30% by weight of said microcomposite units are physically-separable one from the other.

10. The microcomposite of claim 1, wherein at least one dimension of said nucleating component is not greater than about 1 mm.

11. The microcomposite of claim 1, wherein said transcrystalline layer is not less than about 0.1 micrometers thick and not more than about 200 micrometers thick.

12. The microcomposite of claim 1, wherein said transcrystalline layer constitutes not less than about 90% by volume of a corresponding microcomposite unit.

13. The microcomposite of claim 1, wherein said nucleating component comprises a fiber.

14. A method of manufacturing a microcomposite, comprising:
a. providing a melt that comprises a chosen crystallizable thermoplastic polymer, the melt being at a first temperature;
b. providing at least one nucleating component having a nucleating surface;
c. subsequent to ‘a’ and ‘b’, intimately contacting at least part of said nucleating surface of said at least one nucleating component with said melt;
d. subsequent to ‘c’, lowering the temperature of said melt that is in intimate contact with said part of said nucleating surface to a second empirically-predetermined isothermal temperature, lower than said first temperature, at which a transcrystalline layer is nucleated and formed on said nucleating surface intimately contacting said melt and no crystallization occurs in the bulk matrix melt beyond said transcrystalline layer, thereby making an incipient microcomposite comprising said formed transcrystalline layer nucleated on said nucleating surface where pores of said transcrystalline layer are filled with an amorphous polymer phase and bulk polymer matrix melt is outside of said transcrystalline layer;
e. subsequent to ‘d’, when said transcrystalline layer that is formed on portions of said nucleating surface is of a desired thickness and/or has stopped growing, immersing said nucleating surface, said formed transcrystalline layer and bulk polymer matrix melt that is adhered thereto in an extraction solvent suitable for extracting the chosen thermoplastic polymer, so as to remove substantially all of said adhered bulk polymer matrix melt from said outside of said formed transcrystalline layer of said incipient microcomposite, thereby making a microcomposite comprising at least one microcomposite unit that includes at least one nucleating component having a nucleating surface; and nucleated from said nucleating surface, a porous transcrystalline layer of crystallizable thermoplastic polymer, wherein said made microcomposite is substantially devoid of a bulk polymer matrix phase in the volume outside of said porous transcrystalline layer; and
f. removing said microcomposite from immersion in said extraction solvent.

15. The method of claim 14, wherein said intimately contacting ‘c’ at least part of said nucleating surface of said at least one nucleating component with said melt comprises at least partially immersing said at least one nucleating component in said melt so that at least a portion of said nucleating surface is in intimate contact with said melt.

16. The method of claim 14, wherein said intimately contacting ‘c’ at least part of said nucleating surface of said at least one nucleating component with said melt comprises coating at least a portion of said nucleating surface with said melt so that said nucleating surface is in intimate contact with said melt.

17. The method of claim 14, wherein said immersing ‘e’ of said nucleating surface and said formed transcrystalline layer in said extraction solvent is sufficient to remove substantially all of said amorphous polymer phase from said pores of said transcrystalline layer.

18. The method of claim 14, wherein said melt comprises, in addition to said crystallizable thermoplastic polymer a chosen amount of an additive:
said additive being a liquid under the crystallization conditions of said crystallizable thermoplastic polymer from said melt;
said additive being miscible with said crystallizable thermoplastic polymer in said melt so that said melt is homogeneous; and
said additive does not phase-separate from said melt.

19. The method of claim 14, wherein during said intimately contacting of at least part of said nucleating surface of said at least one nucleating component with said melt, said nucleating component is in contact with a substrate or a support.
